(19) United States
(12) Patent Application Publication
(10) Pub. No.: US 2005/0096922 A1
(43) Pub. Date: May 5, 2005

(54) Approximating hierarchies

(76) Inventors: Bernardo Huberman, Palo Alto, CA (US); Joshua Rogers Tyler, Stanford, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/696,339

(22) Filed: Oct. 29, 2003

(51) Int. Cl. G06F 17/60

(52) U.S. Cl. 705/1

(57) ABSTRACT

Acquired data about inter-organizational communication interactions is used to form constructs indicative of a hierarchical structure for an organization. An exemplary graphical layout is shown which may be derived from the addressing data associated with the interactions to depict a communication network construct of the organization over time. Placement of individuals in the graphical construct may be used to infer each individuals placement in an organizational hierarchy construct.

### BACKGROUND

1. Technical Field

The disclosure relates generally to data mining and knowledge discovery.

2. Description of Related Art

A variety of person-to-person communication forms have been created throughout history. While many forms are still in use today, electronic mail, “e-mail,” currently has become a ubiquitous tool in both the business and private sectors of everyday life. The use of e-mail and content of an e-mail message can be analyzed to derive other information not necessarily inherent in the content itself. Natural language processing techniques and pattern recognition techniques when applied to e-mail messaging and e-mail content can be used to derive other, non-inherent, information. For example, within an organization's computer network, based on an analysis of e-mail message header and attachment information, a system administrator may derive reports based on that information rather than the content to determine appropriate uses of e-mail in the network without reading the message content itself. As another example, monitoring and displaying to a user a variety of e-mail usage statistics may provide information that may affect the user's own e-mail usage practices and habits.

Identifying organizational hierarchical structures has been a focus for data mining and knowledge discovery researchers. Organizational hierarchy knowledge may be a useful tool for many types of studies. For example, an organization may have an interest in understanding their formal or informal hierarchy and communication flow as a way of improving knowledge sharing. With respect to businesses, the hierarchical, usually in the form of a known manner “organization chart,” may be often constructed by extensive and expensive manual labor given access to precise, given data, namely, each employee's name, title, ranking of such a title, and the like. There is a need for data mining and knowledge discovery techniques for reducing such extensive manual labor tasks and improving derivative results.

### BRIEF SUMMARY

The invention generally provides for using personal communications data for approximating a hierarchical structure.

The foregoing summary is not intended to be inclusive of all aspects, objects, advantages and features of the present invention nor should any limitation on the scope of the invention be implied therefrom. This Brief Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1 is a flow chart for a generic methodology in accordance with an exemplary embodiment of the present invention.

FIG. 2 is a flow chart for an exemplary graphical tool employed with the exemplary embodiment of the present invention as shown in FIG. 1.

FIG. 3 is an exemplary graphical tool illustrative of visualization of e-mail communications within an organizational structure in accordance with the exemplary embodiment of FIGS. 1 and 2.

FIG. 4 is a flow chart illustrative of an exemplary embodiment of the present invention, depicting a methodology for approximating organization structure in accordance with the embodiment of FIG. 1.

Like reference designations represent like features throughout the drawings. The drawings in this specification should be understood as not being drawn to scale unless specifically annotated as such.

### DETAILED DESCRIPTION

In general, acquired data about inter-organizational communication interactions—such as e-mail, including instant messaging exchanges, telephone call routing connections, voice mail messaging, paper mail, or any like “pairwise,” person-to-person, communication data—may be used to form constructs which are indicative of a hierarchical structure for the organization. A graphical layout, or other imaging diagram, may be derived from the addressing data associated with the interactions to depict a communication network construct of the organization over time. Placement of individuals in the graphical construct is used to infer each individuals placement in an organizational hierarchy construct. In order to describe details of the present invention, an exemplary embodiment using e-mail logs—a substantially complete set of the “To” and “From” information available at the communications network system level during a predetermined, or given, time period—is used for approximating the hierarchical structure of the organization.

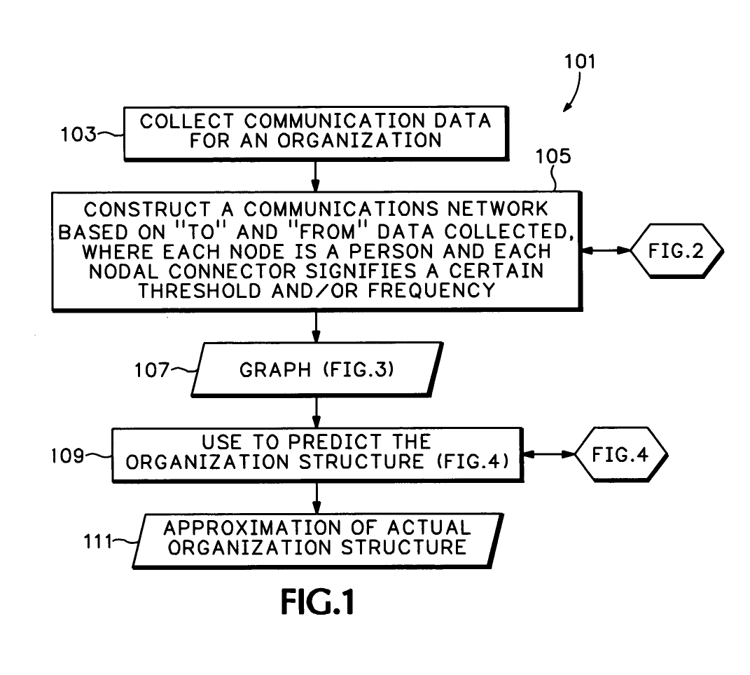

FIG. 1 is a flow chart for a generic methodology in accordance with an exemplary embodiment of the present invention. The process 101 of identifying organizational structure from a substantially random communication network construct may be initiated by collecting 103 communication data for the organization-in-analysis. This data may be any form of pairwise communication, but for this exemplary embodiment is simply a system administrator's access to e-mail messaging “To, “From,” “CC:” and “BCC” data—namely, the addressing information which is inherent in known manner e-mail messaging systems. For simplification of this detailed description, this addressing information is referred to as “To/From data.” Over a given time period, predetermined by the organization or user-analyst to be representative of typical inter-organizational communications, e.g., one day, one week, two months, or the like, this To/From data is gathered.

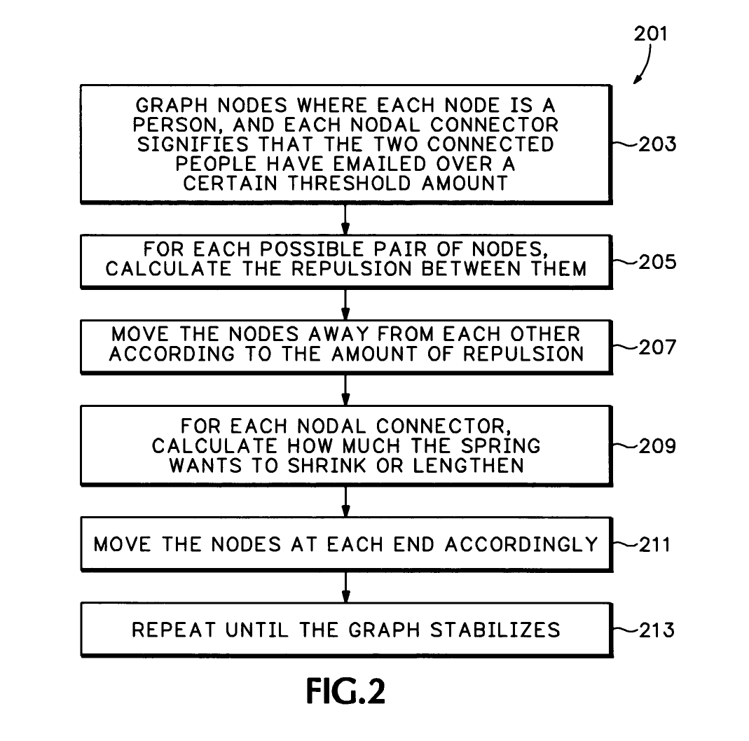

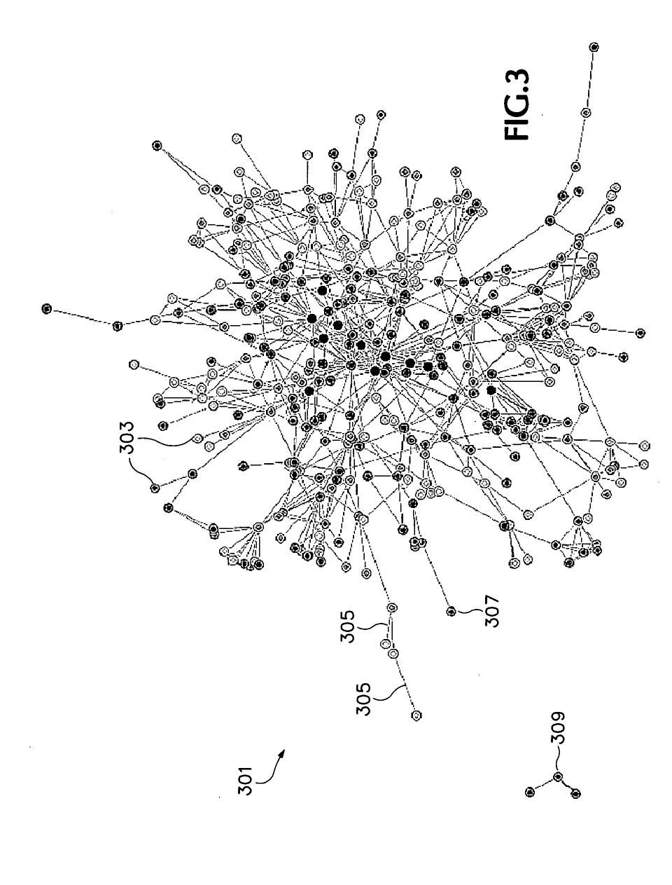

Based on the To/From data, an inter-organizational communications network construct may be formed 105. One methodology 201 for forming a communications network construct is shown in FIG. 2 and a resultant graphical layout 301 appropriate to the exemplary embodiment of the present invention is shown in FIG. 3.

Referring to both FIGS. 2 and 3, basically, the To/From data of each e-mail message between members of the organization-under-study over a given time period may be used to diagram nodes 303, where each node represents a person of the organization. In one aspect, each nodal connector 305 signifies that two connected people have e-mailed over a predetermined threshold amount. Note that in certain cases there may be no connector 305 between two nodes, e.g. between node 307 and node 309, indicating that the threshold has not been achieved. All nodes are considered to have an equal repulsion force associated with them; that is, nodes generally repel each other.

Each nodal connector 305 may be a virtual spring with a given equal spring constant. Since the nodes repel each other, and each spring constant is identical, in the final diagram 301, in effect, the length of each virtual spring may be selected to be inversely proportional to the amount of e-mail between the person nodes 303; in other words, the higher the number of e-mail messages between two nodes, the shorter, “stronger,” the connector may be. Thus, in another aspect, each nodal connector 305 may be also indicative of a higher e-mail messaging frequency between nodes 303 at each end thereof.

A calculation 205 is performed for each possible pair of nodes 303 to determine the repulsion between them; e.g., for a given repulsive force, repulsion may be illustrated as inverse with the square of the distance between them. The nodal pairs in analysis may be moved away from each other according to the calculated amount of repulsion 207.

For each nodal connector 305 inserted once the threshold is achieved between two nodes 303 based on the To/From data 103, how much each spring wants to shrink or lengthen may be calculated 209 based on the frequency of messaging.

Based on the shrink/lengthen calculation 209, the nodes 303 at each end may be moved accordingly.

The process may be repeated 213 for each nodal pair until the diagram 301 is substantially stabilized. In FIG. 2 for example, the nodes may represent people within a given organizations e-mail network who exchanged a minimum threshold number of six e-mail messages over a two week period.

Returning now to FIG. 1, from diagraming 105 the organizational communications network, a graphical representation 107, FIG. 3, was generated 107. It should be recognized that this representation may be useful as work product in and of itself for further analysis goals, depending on the specific implementation of the present invention. While the nodes are shown in grey scale in this specification, note that using a full color layout may provide a better visual representation; in other words, in the final product, the node receiving the highest number of e-mail messages may be the only red node, being indicative of the person related to the node being the head of the organization. All nodes are assumed to have equal mass and repulsion toward each other and all nodal connectors has equal spring constants. Based on the To/From data therefore, the nodes become grey scale shades, or color, coded in accordance with predicted hierarchy depth; the darker the grey, the higher that individual is in the organizational structure. It should be recognized by those skilled in the art that other known manner or proprietary graphical representation techniques may be adapted to and employed in conjunction with specific implementations of the present invention to form a communications network construct. Two dimensional or three dimensional constructs may be employed as needed for a specific implementation.

From the graph 107, a predictive approximation of organizational structure can be derived 109. It should be recognized by those skilled in the art that generation of a communications network image, graph, or other intercommunications construct for the period-in-question, itself may be completely transparent to the user; in other words, the user may be only interested in the goal of generating an organizational hierarchy. Thus, the addressing data may be simply stored in appropriate tables or the like toward achieving this goal.

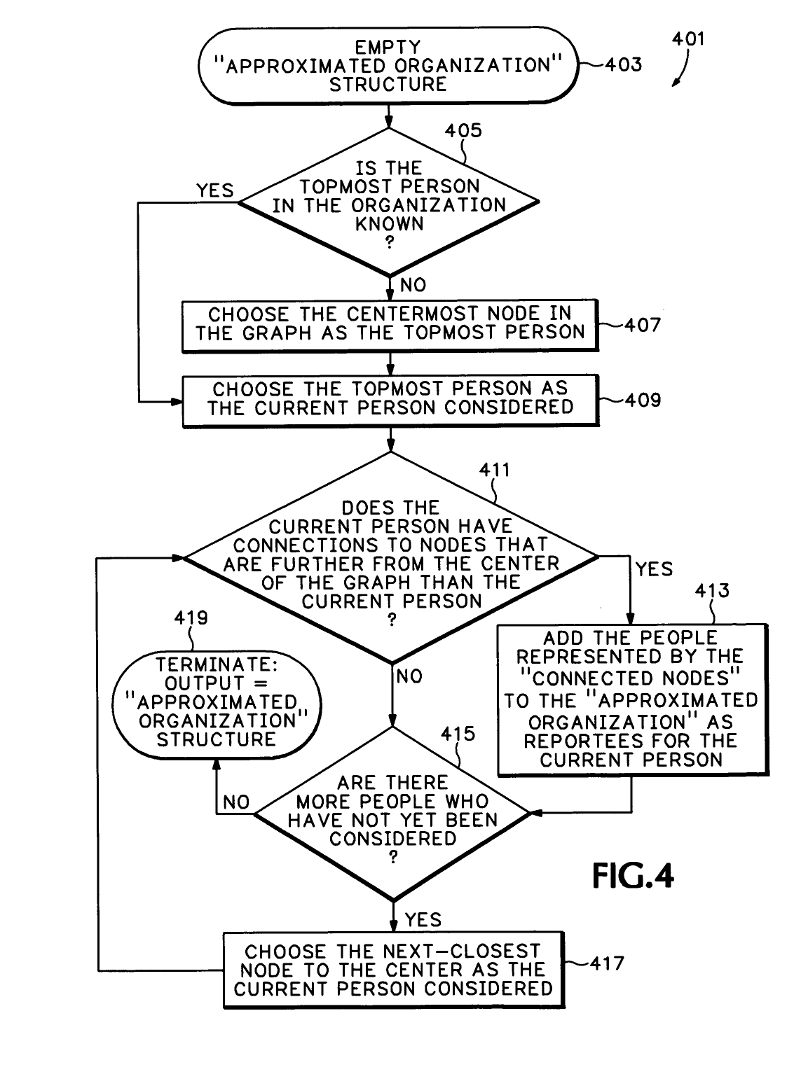

FIG. 4 is a flow chart illustrative of an exemplary embodiment of the present invention, depicting a methodology 401 for approximating organizational hierarchy structure in accordance with the embodiment of FIG. 1. At the start 403, an organization hierarchy construct, e.g., a known manner, pyramid-structure, corporate organization chart, is empty. No persons/nodes have yet been associated with placement positions in the organization chart.

It will be readily apparent that in most corporations, the chief executive officer, “CEO,” is a publically known figure to be placed at the apex of the pyramid. However, the process 401 may be implemented for sub-structures of the organization, such as one operating division within a corporation where such information is not publically available or known to an analyst using the process. Therefore, if the topmost person in the organization known, 405, YES-path, that person/node may be chosen 409 as the current person/node under consideration. If the topmost person in the organization is not known, 405, NO-path, as a hierarchical structure construction starting point, the centermost node in the graph—or other locus depending on the specific implementation—may be assigned 407 as the topmost person. Continuing the corporate operating division example, the centermost node is predicted to be the “Head of Division.” The name of the person associated with the centermost node is assigned to the top of the approximated organization chart. It should be recognized at this point that this approximation may not be true. That is, there may be a member of the organization who received and sent more e-mail during the predetermined time period than the actual Head of Division. Nevertheless, in testing simulations of the present invention, it has been found that the exemplary method employed in the experiment had a better than about sixty-five percent (65%) accuracy in approximating the actual hierarchical structure of the tested organization. When the topmost person is known to start, the accuracy may improve to better than about seventy-five percent (75%).

Once the topmost person is assigned, that topmost person/node 303 is selected 409 as the first, “current,” person/node-under-analysis. Each iteration of the method involving a subsequent person/node 303 becomes the next “current” person/node-under-analysis. A decision 411 is made as to whether the current person/node has nodal connectors 305 to other nodes that are further from the center of the graph than the current person/node. For each current person/node 303 where such a connector 305 exists, 411, YES-path, the persons represented by the connected nodes may be added 413 to the approximated organization structure as direct reportees to the current person/node-under analysis 409. In other words, it may be predicted that those nodes represent persons who are managed directly by the current person/node-under analysis 409 because they have direct e-mail access.

Once those nodes are accounted for 413, or the current person node has no connectors to nodes that are farther from the center of the graph than the current person/node, 411, NO-path, a determination is made 415 preferably as to whether there may be persons/nodes yet to be considered. If so, 415, YES path, the next closest node 3030 to the center of the graph may be selected 417 as the current person/node-under analysis. In this embodiment, the process loops back to step 411. If not, the approximation analysis may be terminated and the approximated organization structure is provided 419, 111 (FIG. 1).

Having been described hereinabove, it should now be apparent to persons skilled in the art that the present invention may be implemented in a software, firmware, or the like, computer program and contained in a computer memory device.

The present invention may be implemented as a method of doing business such as by being a purveyor of software or providing a service in which the business employs the above-described methodologies to present a client organization with a finished product such as a report based on the data mining and knowledge discovery results from analyzing specific communications data provided by the client organization.

It is also to be recognized that only the To/From data may be needed for the analysis of hierarchical structure. In other words, given a database of To/From data for a given set of individual nodal artifices—which may be persons, organizations, collectives, and the like—prediction of some form of relationship between those nodes may be implied.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art, particularly with respect to adaptations for other peer-to-peer communications data such as telephone call logs, instant e-mail messaging exchanges, and the like. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . . ”

1. A method of approximating hierarchy, the method comprising:
over a time period, for a set of communication addresses for members of a given set, collecting data representative of each pairwise communication addressing between said members of a given set; and
based on said data, forming a hierarchy construct of an approximate hierarchical relationship of said members of a given set wherein said relationship is based upon number of pairwise communications between each of said members of a given set.

2. The method as set forth in claim 1 further comprising:
based on said data, forming a communications construct illustrating a communications among said members of a given set such that said construct indicates at least a frequency of intercommunications between said members of a given set wherein said frequency is indicative of hierarchical relationship of said members of a given set.

3. The method as set forth in claim 2 comprising:
said communications construct indicates relative position of said members of a given set with respect to a locus wherein the locus is indicative of the highest position of the hierarchy of said members of a given set.

4. The method as set forth in claim 2 wherein said locus is a centermost position in said communications construct.

5. The method as set forth in claim 2 wherein said communications construct indicates relative position of said members of a given set in said hierarchy by coding nodes representative of said members of a given set with respect to levels of said hierarchy.

6. A method for approximating a hierarchical structure from electronic mail communications, the method comprising:
for a given set of communications network users, collecting addressing data from each electronic mail message sent during a predetermined time period;
from said addressing data, determining the frequency of electronic mail messages between each and every one of said users respectively; and
from said frequency of electronic mail messages, approximating the hierarchical structure of relationship of said users.

7. The method as set forth in claim 6, said determining further comprising:
providing an image illustrative of said frequency of electronic mail messages wherein said image is representative of both communications among said users and hierarchical relationship of said users.

8. A system for approximating a hierarchical relationship of members of a communications network, the system comprising:
means for collecting addressing data for each pairwise communication between each of the members of said network; and
means for analyzing said addressing data and for approximating the hierarchical relationship of members therefrom.

9. The system as set forth in claim 8 wherein said means for analyzing said addressing data and for approximating the hierarchical relationship therefrom further comprises:
means for constructing a graphical illustration of said communications network wherein said illustration has nodes representative of each of said members and nodal connectors representative of a threshold of said pairwise communications between said nodes and frequency of said pairwise communications above said threshold.

10. The system as set forth in claim 9 wherein a locus of said graphical illustration is representative of topmost member of said communications network.

11. The system as set forth in claim 10 wherein said locus is a centermost node of said graphical illustration.

12. A computer memory device comprising:
computer code for gathering data representative of addressing information inherent in pairwise communications between members of a set; and
computer code for generating from gathered said data a hierarchy of said members based upon frequency of the pairwise communications between each pair of said members.

13. The device as set forth in claim 12 comprising:
computer means for generating a graphical illustration of said hierarchy.

14. The device as set forth in claim 12 comprising:
computer means for generating a graphical illustration of communications between said members wherein said illustration depicts both said hierarchy and at least frequency of communications between said members.

15. A method of doing business comprising:
for a given set of members of a communications network, receiving addressing data representative of each and every communication between any two said members over a predetermined time period;
analyzing said data for at least frequency of communications between each and every member of said set; and
from said analyzing, providing an approximated hierarchical relationship of said members.

16. The method as set forth in claim 15 wherein said analyzing further comprises:
forming an image of a communications network among said members.

17. The method as set forth in claim 16 wherein said forming an image further comprises graphically illustrating said hierarchical relationship.

18. The method as set forth in claim 16 wherein said forming an image further comprises graphically illustrating frequency of communications between said members.

19. A method for approximating an organizational hierarchy based on electronic mail communications between individuals, the method comprising:
forming a database from addressing information inherent in electronic mail messages between each and every one of said individuals over a predetermined time period;
using all said addressing information in said database, forming a graphical image of network communications wherein each node represents a given one of said individuals and nodal connectors between nodes represent a predetermined threshold number of electronic mail messages between nodes connected thereby and length of said nodal connectors is representative of number of electronic mail messages above said threshold wherein said nodes are color coded according to position within said image and said color coding is representative of position in an approximated organizational hierarchy for said individuals; and
using said image, generating an image of said approximated organizational hierarchy in a form of a standard organizational chart.
